(19) United States
(12) Patent Application Publication
(10) Pub. No.: US 2022/0188473 A1
(43) Pub. Date: Jun. 16, 2022

(54) METHODS AND SYSTEMS FOR FACILITATING DESIGNING OF FURNITURE

(71) Applicant: Henry Vuu, Westminster, CA (US)

(72) Inventor: Henry Vuu, Westminster, CA (US)

(21) Appl. No.: 17/119,991

(22) Filed: Dec. 11, 2020

(51) Int. Cl. G06F 30/13

(52) U.S. Cl. CPC G06F 30/13; G06F 2111/16

(57) ABSTRACT

Disclosed herein is a method for facilitating designing of furniture. Accordingly, the method comprises receiving room information from a user device, analyzing the room information, generating a room model of the room based on the analyzing, retrieving furniture representations, transmitting the furniture representations to the user device, receiving a furniture indication from the user device, retrieving a furniture model of the furniture based on the furniture indication, generating a furnished room model based on the furniture model and the room model, transmitting the furnished room model to the user device, receiving a furniture feature modification information from the user device, modifying a furniture model parameter of the furniture model, generating a modified furniture model based on the modifying, generating a modified furnished room model based on the modified furniture model and the room model, and transmitting the modified furnished room model to the user device.

### FIELD OF THE INVENTION

Generally, the present disclosure relates to the field of data processing. More specifically, the present disclosure relates to methods and systems for facilitating designing of furniture.

### BACKGROUND OF THE INVENTION

Furniture is an essential part of a room in a housing facility or a workplace. Nowadays, designing furniture is given significant importance as the furniture is considered a form of decorative commodity. Individuals are more conscious than ever of the furniture. Furniture reflects a sense of style of an individual. Consequently, the individuals are opting for customized designing of the furniture based on individual preferences (such as dimension, appearance, frame, appearance, etc.). Further, the furniture should be designed in line with a location and an interior design of the housing facility.

Therefore, there is a need for improved methods and systems for facilitating designing of furniture that may overcome one or more of the above-mentioned problems and/or limitations.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

Disclosed herein is a method for facilitating designing of furniture, in accordance with some embodiments. Accordingly, the method may include a step of receiving, using a communication device, room information associated with a room from at least one user device. Further, the method may include a step of analyzing, using a processing device, the room information. Further, the method may include a step of generating, using the processing device, a room model of the room based on the analyzing of the room information. Further, the method may include a step of retrieving, using a storage device, a plurality of furniture representations associated with a plurality of furniture. Further, the plurality of furniture may be disposable in the room. Further, each furniture of the plurality of furniture may be characterized by at least one furniture feature, wherein the at least one furniture feature may be customizable. Further, the method may include a step of transmitting, using the communication device, the plurality of furniture representations associated with the plurality of furniture to the at least one user device. Further, the method may include a step of receiving, using the communication device, at least one furniture indication associated with at least one furniture of the plurality of furniture from the at least one user device. Further, the method may include a step of retrieving, using the storage device, at least one furniture model of the at least one furniture based on the at least one furniture indication. Further, the at least one furniture model may be characterized by at least one furniture model parameter corresponding to the at least one furniture feature. Further, the method may include a step of generating, using the processing device, a furnished room model based on the at least one furniture model and the room model. Further, the method may include a step of transmitting, using the communication device, the furnished room model to the at least one user device. Further, the method may include a step of receiving, using the communication device, at least one furniture feature modification information associated with the at least one furniture feature of the at least one furniture from the at least one user device. Further, the method may include a step of modifying, using the processing device, the at least one furniture model parameter of the at least one furniture model based on the at least one furniture feature modification information. Further, the method may include a step of generating, using the processing device, at least one modified furniture model based on the modifying. Further, the method may include a step of generating, using the processing device, a modified furnished room model based on the at least one modified furniture model and the room model. Further, the method may include a step of transmitting, using the communication device, the modified furnished room model to the at least one user device.

Further disclosed herein is a system for facilitating designing of furniture, in accordance with some embodiments. Accordingly, the system may include a communication device configured for receiving room information associated with a room from at least one user device. Further, the communication device may be configured for transmitting a plurality of furniture representations associated with a plurality of furniture to the at least one user device. Further, the communication device may be configured for receiving at least one furniture indication associated with at least one furniture of the plurality of furniture from the at least one user device. Further, the communication device may be configured for transmitting a furnished room model to the at least one user device. Further, the communication device may be configured for receiving at least one furniture feature modification information associated with the at least one furniture feature of the at least one furniture from the at least one user device. Further, the communication device may be configured for transmitting a modified furnished room model to the at least one user device. Further, the system may include a processing device communicatively coupled with the communication device. Further, the processing device may be configured for analyzing the room information. Further, the processing device may be configured for generating a room model of the room based on the analyzing of the room information. Further, the processing device may be configured for generating the furnished room model based on at least one furniture model and the room model. Further, the processing device may be configured for modifying the at least one furniture model parameter of the at least one furniture model based on the at least one furniture feature modification information. Further, the processing device may be configured for generating at least one modified furniture model based on the modifying. Further, the processing device may be configured for generating the modified furnished room model based on the at least one modified furniture model and the room model. Further, the system may include a storage device communicatively coupled with the processing device. Further, the storage device may be configured for retrieving the plurality of furniture representations associated with the plurality of furniture. Further, the plurality of furniture may be disposable in the room. Further, each furniture of the plurality of furniture may be characterized by at least one furniture feature, wherein the at least one furniture feature may be customizable. Further, the storage device may be configured for retrieving the at least one furniture model of the at least one furniture based on the at least one furniture indication. Further, the at least one furniture model may be characterized by at least one furniture model parameter corresponding to the at least one furniture feature.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of an online platform consistent with various embodiments of the present disclosure.

FIG. 2 is a block diagram of a system for facilitating designing of furniture, in accordance with some embodiments.

FIG. 3 is a block diagram of the system for facilitating the designing of the furniture, in accordance with some embodiments.

FIG. 4 is a block diagram of the system for facilitating the designing of the furniture, in accordance with some embodiments.

FIG. 5 is a block diagram of the system for facilitating the designing of the furniture, in accordance with some embodiments.

FIG. 6 is a flowchart of a method for facilitating designing of furniture, in accordance with some embodiments.

FIG. 7 is a flowchart of a method for generating cost data for facilitating the designing of the furniture, in accordance with some embodiments.

FIG. 8 is a flowchart of a method for modifying at least one room model parameter for facilitating the designing of the furniture, in accordance with some embodiments.

FIG. 9 is a flowchart of a method for modifying at least one first furniture model parameter for facilitating the designing of the furniture, in accordance with some embodiments.

FIG. 10 is a flowchart of a method for modifying at least one second furniture model parameter for facilitating the designing of the furniture, in accordance with some embodiments.

FIG. 11 is a flowchart of a method for generating a body model for facilitating the designing of the furniture, in accordance with some embodiments.

FIG. 12 is a flowchart of a method for generating at least one customizing recommendation for facilitating the designing of the furniture, in accordance with some embodiments.

FIG. 13 is a flowchart of a method for generating at least one customizing recommendation for facilitating the designing of the furniture, in accordance with some embodiments.

FIG. 14 is a block diagram of a computing device for implementing the methods disclosed herein, in accordance with some embodiments.

### DETAIL DESCRIPTIONS OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of methods and systems of facilitating designing of furniture, embodiments of the present disclosure are not limited to use only in this context.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, at least one network device, at least one sensor and at least one actuator. Examples of the one or more client devices and/or the server computer may include, a desktop computer, a laptop computer, a tablet computer, a personal digital assistant, a portable electronic device, a wearable computer, a smart phone, an Internet of Things (IoT) device, a smart electrical appliance, a video game console, a rack server, a super-computer, a mainframe computer, mini-computer, micro-computer, a storage server, an application server (e.g. a mail server, a web server, a real-time communication server, an FTP server, a virtual server, a proxy server, a DNS server etc.), a quantum computer, and so on. Further, one or more client devices and/or the server computer may be configured for executing a software application such as, for example, but not limited to, an operating system (e.g. Windows, Mac OS, Unix, Linux, Android, etc.) in order to provide a user interface (e.g. GUI, touch-screen based interface, voice based interface, gesture based interface etc.) for use by the one or more users and/or a network interface for communicating with other devices over a communication network. Accordingly, the server computer may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the server computer may include a communication device configured for communicating with one or more external devices. The one or more external devices may include, for example, but are not limited to, a client device, a third party database, public database, a private database and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data finger-printing, role based access control, and so on.

Further, one or more steps of the method disclosed herein may be initiated, maintained, controlled and/or terminated based on a control input received from one or more devices operated by one or more users such as, for example, but not limited to, an end user, an admin, a service provider, a service consumer, an agent, a broker and a representative thereof. Further, the user as defined herein may refer to a human, an animal or an artificially intelligent being in any state of existence, unless stated otherwise, elsewhere in the present disclosure. Further, in some embodiments, the one or more users may be required to successfully perform authentication in order for the control input to be effective. In general, a user of the one or more users may perform authentication based on the possession of a secret human readable secret data (e.g. username, password, passphrase, PIN, secret question, secret answer etc.) and/or possession of a machine readable secret data (e.g. encryption key, decryption key, bar codes, etc.) and/or or possession of one or more embodied characteristics unique to the user (e.g. biometric variables such as, but not limited to, fingerprint, palm-print, voice characteristics, behavioral characteristics, facial features, iris pattern, heart rate variability, evoked potentials, brain waves, and so on) and/or possession of a unique device (e.g. a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g. transmitting and/or receiving) with one or more sensor devices and/or one or more actuators in order to perform authentication. For example, the one or more steps may include receiving, using the communication device, the secret human readable data from an input device such as, for example, a keyboard, a keypad, a touch-screen, a microphone, a camera and so on. Likewise, the one or more steps may include receiving, using the communication device, the one or more embodied characteristics from one or more biometric sensors.

Further, one or more steps of the method may be automatically initiated, maintained and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g. the server computer, a client device etc.) corresponding to the performance of the one or more steps, physical state and/or physiological state and/or psychological state of the user, physical state (e.g. motion, direction of motion, orientation, speed, velocity, acceleration, trajectory, etc.) of the device corresponding to the performance of the one or more steps and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g. a real-time clock), a location sensor (e.g. a GPS receiver, a GLONASS receiver, an indoor location sensor etc.), a biometric sensor (e.g. a fingerprint sensor), an environmental variable sensor (e.g. temperature sensor, humidity sensor, pressure sensor, etc.) and a device state sensor (e.g. a power sensor, a voltage/current sensor, a switch-state sensor, a usage sensor, etc. associated with the device corresponding to performance of the or more steps).

Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performance of any two steps of the one or more steps.

Further, in some embodiments, the one or more predefined conditions may be specified by the one or more users. Accordingly, the one or more steps may include receiving, using the communication device, the one or more predefined conditions from one or more and devices operated by the one or more users. Further, the one or more predefined conditions may be stored in the storage device. Alternatively, and/or additionally, in some embodiments, the one or more predefined conditions may be automatically determined, using the processing device, based on historical data corresponding to performance of the one or more steps. For example, the historical data may be collected, using the storage device, from a plurality of instances of performance of the method. Such historical data may include performance actions (e.g. initiating, maintaining, interrupting, terminating, etc.) of the one or more steps and/or the one or more contextual variables associated therewith. Further, machine learning may be performed on the historical data in order to determine the one or more predefined conditions. For instance, machine learning on the historical data may determine a correlation between one or more contextual variables and performance of the one or more steps of the method. Accordingly, the one or more predefined conditions may be generated, using the processing device, based on the correlation.

Further, one or more steps of the method may be performed at one or more spatial locations. For instance, the method may be performed by a plurality of devices interconnected through a communication network. Accordingly, in an example, one or more steps of the method may be performed by a server computer. Similarly, one or more steps of the method may be performed by a client computer. Likewise, one or more steps of the method may be performed by an intermediate entity such as, for example, a proxy server. For instance, one or more steps of the method may be performed in a distributed fashion across the plurality of devices in order to meet one or more objectives. For example, one objective may be to provide load balancing between two or more devices. Another objective may be to restrict a location of one or more of an input data, an output data and any intermediate data therebetween corresponding to one or more steps of the method. For example, in a client-server environment, sensitive data corresponding to a user may not be allowed to be transmitted to the server computer. Accordingly, one or more steps of the method operating on the sensitive data and/or a derivative thereof may be performed at the client device.

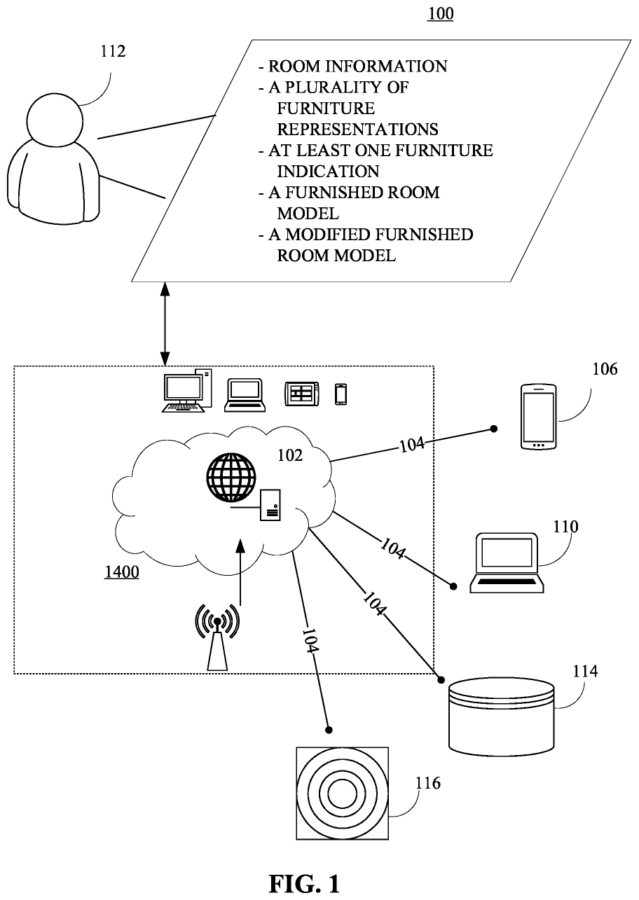

Referring now to figures, FIG. 1 is an illustration of an online platform 100 consistent with various embodiments of the present disclosure. By way of non-limiting example, the online platform 100 to facilitate designing of furniture may be hosted on a centralized server 102, such as, for example, a cloud computing service. The centralized server 102 may communicate with other network entities, such as, for example, a mobile device 106 (such as a smartphone, a laptop, a tablet computer etc.), other electronic devices 110 (such as desktop computers, server computers etc.), databases 114, and sensors 116 over a communication network 104, such as, but not limited to, the Internet. Further, users of the online platform 100 may include relevant parties such as, but not limited to, end-users, administrators, service providers, service consumers and so on. Accordingly, in some instances, electronic devices operated by the one or more relevant parties may be in communication with the platform.

A user 112, such as the one or more relevant parties, may access online platform 100 through a web based software application or browser. The web based software application may be embodied as, for example, but not be limited to, a website, a web application, a desktop application, and a mobile application compatible with a computing device 1400.

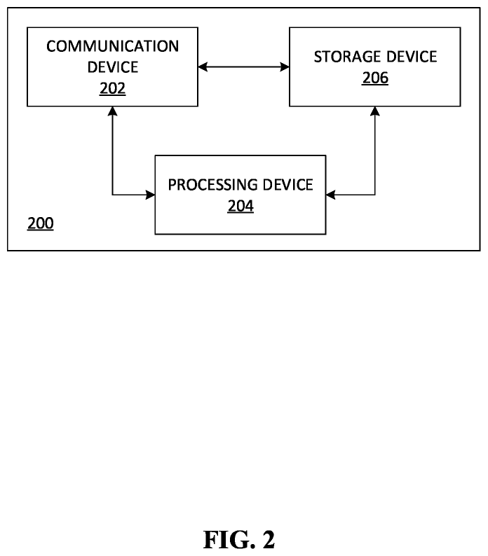

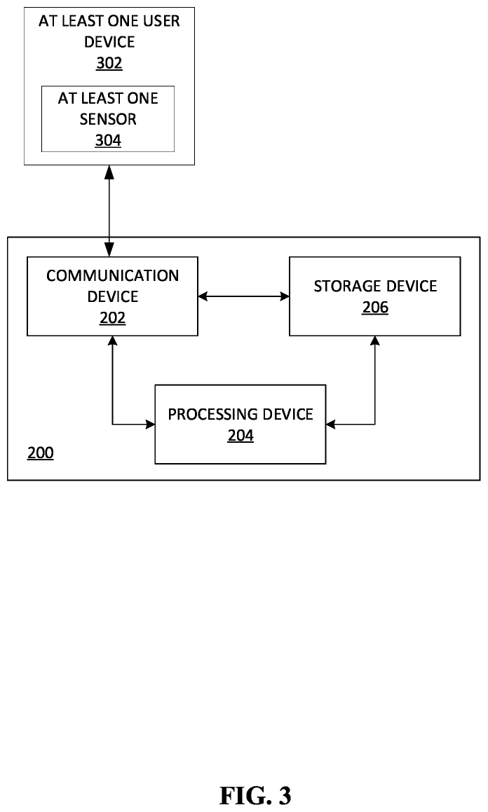

FIG. 2 is a block diagram of a system 200 for facilitating designing of furniture, in accordance with some embodiments. Accordingly, the system 200 may include a communication device 202 configured for receiving room information associated with a room from at least one user device 302 (as shown in FIG. 3). Further, the communication device 202 may be configured for transmitting a plurality of furniture representations associated with a plurality of furniture to the at least one user device 302. Further, the communication device 202 may be configured for receiving at least one furniture indication associated with at least one furniture of the plurality of furniture from the at least one user device 302. Further, the communication device 202 may be configured for transmitting a furnished room model to the at least one user device 302. Further, the communication device 202 may be configured for receiving at least one furniture feature modification information associated with the at least one furniture feature of the at least one furniture from the at least one user device 302. Further, the communication device 202 may be configured for transmitting a modified furnished room model to the at least one user device 302. Further, the furniture may include a sofa, a chair, a couch, a bed, etc. Further, the room may include at least one wall, a floor, a ceiling, at least one window, at least one door, at least one decoration, etc.

Further, the system 200 may include a processing device 204 communicatively coupled with the communication device 202. Further, the processing device 204 may be configured for analyzing the room information. Further, the processing device 204 may be configured for generating a room model of the room based on the analyzing of the room information. Further, the processing device 204 may be configured for generating the furnished room model based on at least one furniture model and the room model. Further, the processing device 204 may be configured for modifying the at least one furniture model parameter of the at least one furniture model based on the at least one furniture feature modification information. Further, the processing device 204 may be configured for generating at least one modified furniture model based on the modifying. Further, the processing device 204 may be configured for generating the modified furnished room model based on the at least one modified furniture model and the room model. Further, the room model may include a 2D room model, a 3D room model, etc. Further, the furnished room model may include the room model populated with the at least one furniture model. Further, the system 200 may include a storage device 206 communicatively coupled with the processing device 204. Further, the storage device 206 may be configured for retrieving the plurality of furniture representations associated with the plurality of furniture. Further, the plurality of furniture may be disposable in the room. Further, each furniture of the plurality of furniture may be characterized by at least one furniture feature, wherein the at least one furniture feature may be customizable. Further, the storage device 206 may be configured for retrieving the at least one furniture model of the at least one furniture based on the at least one furniture indication. Further, the at least one furniture model may be characterized by at least one furniture model parameter corresponding to the at least one furniture feature. Further, the at least one furniture feature may include at least one visual furniture feature, at least one structural furniture feature, etc. Further, at least one of the at least one structural furniture feature and the at least one visual furniture feature characterizes a plurality of furniture components of the furniture. Further, the at least one visual furniture feature may include a color, a texture, etc. of the furniture. Further, the at least one structural furniture feature may include a furniture dimension of the furniture. Further, the furniture may include a sofa. Further, the plurality of furniture components of the sofa may include a seat, a backrest, an arm, a base stand, a cushion, a pillow, welt cords, nail heads, a cover (a leather cover or a fabric cover), etc. Further, the at least one structural furniture feature of the sofa may include a sofa dimension. Further, the sofa dimension may include a sofa length, a sofa depth, a sofa height, a sofa seat depth, a sofa seat height, etc. Further, the at least one structural furniture feature of the plurality of furniture components of the sofa may include a number of seats, a seat design of the seat, an arm design of the arm, a pillow design of the pillow, a nail heads design of the nail heads, a base stand design of the base stand, a cover design of the cover, a cushion design of the cushion, a welt cord design of welt cords, etc. Further, the at least one furniture model may include at least one 2D furniture model, at least one 3D furniture model, etc.

Further, in some embodiments, the communication device 202 may be configured for receiving at least one sensor data from the at least one user device 302. Further, the at least one user device 302 may include at least one sensor 304 (as shown in FIG. 3). Further, the at least one sensor 304 may be configured for generating the at least one sensor data based on a location of a user. Further, the communication device 202 may be configured for transmitting cost data to the at least one user device 302. Further, the processing device 204 may be configured for analyzing the at least one sensor data and the at least one modified furniture model. Further, the processing device 204 may be configured for generating the cost data associated with a cost of the at least one furniture based on the analyzing of the at least one sensor data and the at least one modified furniture model.

Further, in some embodiments, the room information may include at least one room feature modification information. Further, the communication device 202 may be configured for transmitting a primary room model of the room to the at least one user device 302.

Further, the room may be characterized by at least one room feature. Further, the processing device 204 may be configured for modifying at least one room model parameter of the primary room model corresponding to the at least one room feature based on the at least one room feature modification information. Further, the generating of the room model may be based on the modifying of the at least one room model parameter. Further, the at least one room feature may include at least one room visual feature, at least one room structural feature, etc. Further, at least one of the at least one room visual feature and the at least one room structural feature characterizes at least one room component of the room. Further, the at least one room component may include at least one wall, a floor, a ceiling, at least one window, at least one door, at least one decoration, etc.

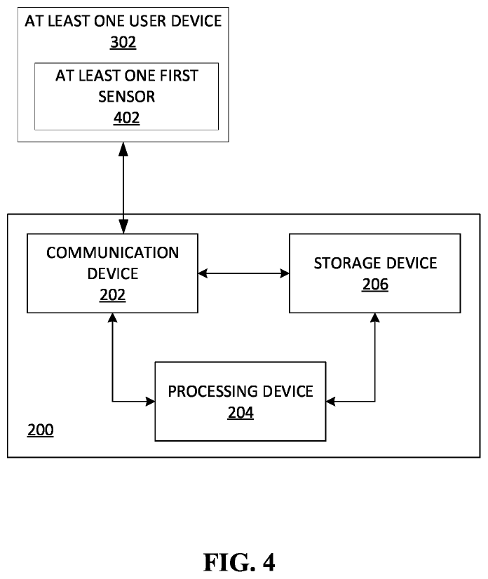

Further, in some embodiments, the at least one user device 302 may include at least one first sensor 402 (as shown in FIG. 4). Further, the at least one first sensor 402 may be configured for capturing at least one image of the room. Further, the room information may include the at least one image of the room. Further, the at least one first sensor 402 may include an imaging sensor. Further, the imaging sensor may include a camera.

Further, in some embodiments, the at least one furniture feature may include at least one first furniture feature. Further, the at least one furniture model may include at least one first furniture model parameter corresponding to the at least one first furniture feature. Further, the processing device 204 may be configured for analyzing the room model and the at least one furniture model. Further, the processing device 204 may be configured for modifying the at least one first furniture model parameter of the at least one furniture model based on the analyzing of the room model and the at least one furniture model. Further, the generating of the at least one modified furniture model may be based on the modifying of the at least one first furniture model parameter.

Further, in some embodiments, the at least one furniture feature may include at least one second furniture feature. Further, the at least one furniture model may include at least one second furniture model parameter corresponding to the at least one second furniture feature. Further, the communication device 202 may be configured for receiving body measurement data associated with a body of a user from the at least one user device 302. Further, the body measurement data may include at least one measurement of at least one of a shape, a size, and a weight of the body. Further, the processing device 204 may be configured for analyzing the body measurement data and the at least one furniture model. Further, the processing device 204 may be configured for modifying the at least one second furniture model parameter of the at least one furniture model based on the analyzing of the body measurement data and the at least one furniture model. Further, the generating of the at least one modified furniture model may be further based on the modifying of the at least one second furniture model parameter.

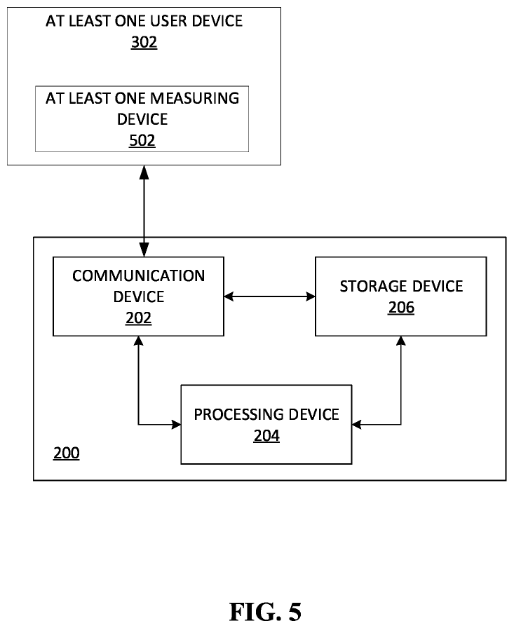

Further, in some embodiments, the at least one user device 302 may include at least one measuring device 502 (as shown in FIG. 5). Further, the at least one measuring device 502 may be configured for measuring the at least one of the shape, the size, and the weight of the body. Further, the at least one measuring device 502 may be configured for generating the at least one measurement of the at least one of the shape, the size, and the weight of the body based on the measuring.

Further, in some embodiments, the communication device 202 may be configured for receiving body measurement data associated with a body of a user from the at least one user device 302. Further, the body measurement data may include at least one measurement of at least one of a shape, a size, and a weight of the body. Further, the processing device 204 may be configured for analyzing the body measurement data. Further, the processing device 204 may be configured for generating a body model of the body of the user based on the analyzing of the body measurement data. Further, the generating of the furnished room model may be based on the body model. Further, the body model may include a 2d body model, a 3d body model, etc.

Further, in some embodiments, the processing device 204 may be configured for analyzing the at least one furniture model and the room model. Further, the processing device 204 may be configured for generating at least one customizing recommendation for the at least one furniture feature based on the analyzing of the at least one furniture model and the room model. Further, the communication device 202 may be configured for transmitting the at least one customizing recommendation to the at least one user device 302. Further, the at least one furniture feature modification information corresponds to the at least one customizing recommendation.

Further, in some embodiments, the at least one furniture may include a plurality of furniture components. Further, the plurality of furniture components may be customizable. Further, the communication device 202 may be configured for receiving at least one furniture component modification information associated with at least one furniture component of the plurality of furniture components from the at least one user device 302. Further, the processing device 204 may be configured for modifying the at least one furniture model based on the at least one furniture component modification information. Further, the generating of the at least one modified furniture model may be based on the modifying of the at least one furniture model.

FIG. 3 is a block diagram of the system 200 for facilitating the designing of the furniture, in accordance with some embodiments.

FIG. 4 is a block diagram of the system 200 for facilitating the designing of the furniture, in accordance with some embodiments.

FIG. 5 is a block diagram of the system 200 for facilitating the designing of the furniture, in accordance with some embodiments.

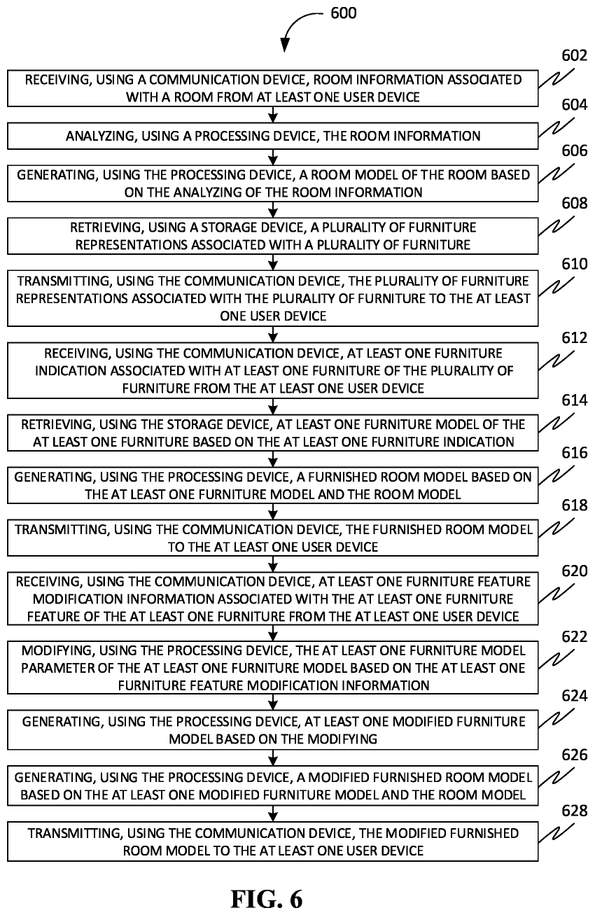

FIG. 6 is a flowchart of a method 600 for facilitating designing of furniture, in accordance with some embodiments. Accordingly, at 602, the method 600 may include a step of receiving, using a communication device, room information associated with a room from at least one user device. Further, the furniture may include a sofa, a chair, a couch, a bed, etc. Further, the room may include at least one wall, a floor, a ceiling, at least one window, at least one door, at least one decoration, etc.

Further, at 604, the method 600 may include a step of analyzing, using a processing device, the room information.

Further, at 606, the method 600 may include a step of generating, using the processing device, a room model of the room based on the analyzing of the room information. Further, the room model may include a 2D room model, a 3D room model, etc.

Further, at 608, the method 600 may include a step of retrieving, using a storage device, a plurality of furniture representations associated with a plurality of furniture. Further, the plurality of furniture may be disposable in the room. Further, each furniture of the plurality of furniture may be characterized by at least one furniture feature, wherein the at least one furniture feature may be customizable. Further, the at least one furniture feature may include at least one visual furniture feature, at least one structural furniture feature, etc. Further, at least one of the at least one structural furniture feature and the at least one visual furniture feature characterizes a plurality of furniture components of the furniture. Further, the at least one visual furniture feature may include a color, a texture, etc. of the furniture. Further, the at least one structural furniture feature may include a furniture dimension of the furniture. Further, the furniture may include a sofa. Further, the plurality of furniture components of the sofa may include a seat, a backrest, an arm, a base stand, a cushion, a pillow, welt cords, nail heads, a cover (a leather cover or a fabric cover), etc. Further, the at least one structural furniture feature of the sofa may include a sofa dimension. Further, the sofa dimension may include a sofa length, a sofa depth, a sofa height, a sofa seat depth, a sofa seat height, etc. Further, the at least one structural furniture feature of the plurality of furniture components of the sofa may include a number of seats, a seat design of the seat, an arm design of the arm, a pillow design of the pillow, a nail heads design of the nail heads, a base stand design of the base stand, a cover design of the cover, a cushion design of the cushion, a welt cord design of welt cords, etc.

Further, at 610, the method 600 may include a step of transmitting, using the communication device, the plurality of furniture representations associated with the plurality of furniture to the at least one user device.

Further, at 612, the method 600 may include a step of receiving, using the communication device, at least one furniture indication associated with at least one furniture of the plurality of furniture from the at least one user device.

Further, at 614, the method 600 may include a step of retrieving, using the storage device, at least one furniture model of the at least one furniture based on the at least one furniture indication. Further, the at least one furniture model may be characterized by at least one furniture model parameter corresponding to the at least one furniture feature. Further, the at least one furniture model may include at least one 2D furniture model, at least one 3D furniture model, etc.

Further, at 616, the method 600 may include a step of generating, using the processing device, a furnished room model based on the at least one furniture model and the room model. Further, the furnished room model may include the room model populated with the at least one furniture model.

Further, at 618, the method 600 may include a step of transmitting, using the communication device, the furnished room model to the at least one user device.

Further, at 620, the method 600 may include a step of receiving, using the communication device, at least one furniture feature modification information associated with the at least one furniture feature of the at least one furniture from the at least one user device.

Further, at 622, the method 600 may include a step of modifying, using the processing device, the at least one furniture model parameter of the at least one furniture model based on the at least one furniture feature modification information.

Further, at 624, the method 600 may include a step of generating, using the processing device, at least one modified furniture model based on the modifying.

Further, at 626, the method 600 may include a step of generating, using the processing device, a modified furnished room model based on the at least one modified furniture model and the room model.

Further, at 628, the method 600 may include a step of transmitting, using the communication device, the modified furnished room model to the at least one user device.

Further, in some embodiments, the at least one user device may include at least one first sensor. Further, the at least one first sensor may be configured for capturing at least one image of the room. Further, the room information may include the at least one image of the room.

Further, in some embodiments, the at least one user device may include at least one measuring device. Further, the at least one measuring device may be configured for measuring the at least one of the shape, the size, and the weight of the body. Further, the at least one measuring device may be configured for generating the at least one measurement of the at least one of the shape, the size, and the weight of the body based on the measuring.

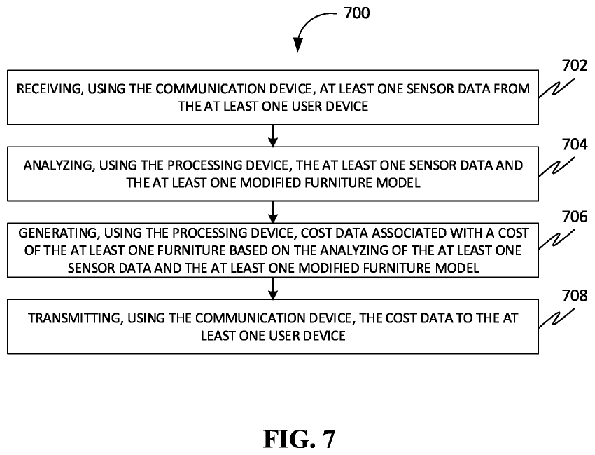

FIG. 7 is a flowchart of a method 700 for generating cost data for facilitating the designing of the furniture, in accordance with some embodiments. Accordingly, at 702, the method 700 may include receiving, using the communication device, at least one sensor data from the at least one user device. Further, the at least one user device may include at least one sensor. Further, the at least one sensor may be configured for generating the at least one sensor data based on a location of a user.

Further, at 704, the method 700 may include a step of analyzing, using the processing device, the at least one sensor data and the at least one modified furniture model.

Further, at 706, the method 700 may include a step of generating, using the processing device, cost data associated with a cost of the at least one furniture based on the analyzing of the at least one sensor data and the at least one modified furniture model.

Further, at 708, the method 700 may include a step of transmitting, using the communication device, the cost data to the at least one user device.

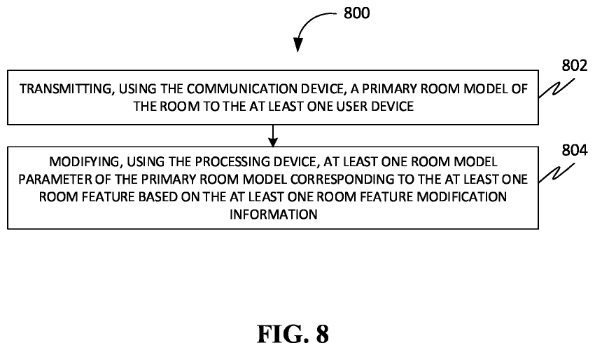

FIG. 8 is a flowchart of a method 800 for modifying at least one room model parameter for facilitating the designing of the furniture, in accordance with some embodiments. Accordingly, the room information may include at least one room feature modification information. Further, at 802, the method 800 may include transmitting, using the communication device, a primary room model of the room to the at least one user device. Further, the room may be characterized by at least one room feature. Further, the at least one room feature may include at least one room visual feature, at least one room structural feature, etc. Further, at least one of the at least one room visual feature and the at least one room structural feature characterizes at least one room component of the room. Further, the at least one room component may include at least one wall, a floor, a ceiling, at least one window, at least one door, at least one decoration, etc.

Further, at 804, the method 800 may include a step of modifying, using the processing device, at least one room model parameter of the primary room model corresponding to the at least one room feature based on the at least one room feature modification information. Further, the generating of the room model may be based on the modifying of the at least one room model parameter.

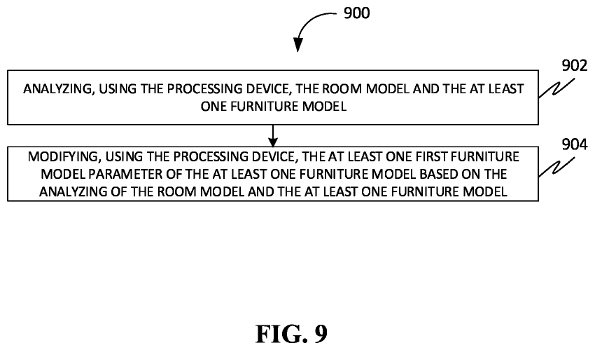

FIG. 9 is a flowchart of a method 900 for modifying at least one first furniture model parameter for facilitating the designing of the furniture, in accordance with some embodiments. Accordingly, the at least one furniture feature may include at least one first furniture feature. Further, the at least one furniture model may include at least one first furniture model parameter corresponding to the at least one first furniture feature. Further, at 902, the method 900 may include a step of analyzing, using the processing device, the room model and the at least one furniture model.

Further, at 904, the method 900 may include a step of modifying, using the processing device, the at least one first furniture model parameter of the at least one furniture model based on the analyzing of the room model and the at least one furniture model. Further, the generating of the at least one modified furniture model may be based on the modifying of the at least one first furniture model parameter.

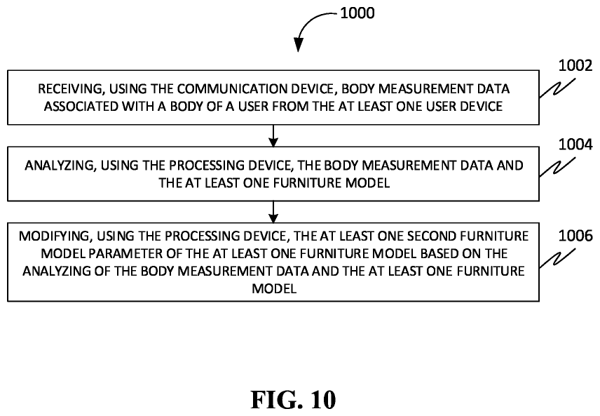

FIG. 10 is a flowchart of a method 1000 for modifying at least one second furniture model parameter for facilitating the designing of the furniture, in accordance with some embodiments. Accordingly, the at least one furniture feature may include at least one second furniture feature. Further, the at least one furniture model may include at least one second furniture model parameter corresponding to the at least one second furniture feature. Further, at 1002, the method 1000 may include a step of receiving, using the communication device, body measurement data associated with a body of a user from the at least one user device. Further, the body measurement data may include at least one measurement of at least one of a shape, a size, and a weight of the body.

Further, at 1004, the method 1000 may include a step of analyzing, using the processing device, the body measurement data and the at least one furniture model.

Further, at 1006, the method 1000 may include a step of modifying, using the processing device, the at least one second furniture model parameter of the at least one furniture model based on the analyzing of the body measurement data and the at least one furniture model. Further, the generating of the at least one modified furniture model may be further based on the modifying of the at least one second furniture model parameter.

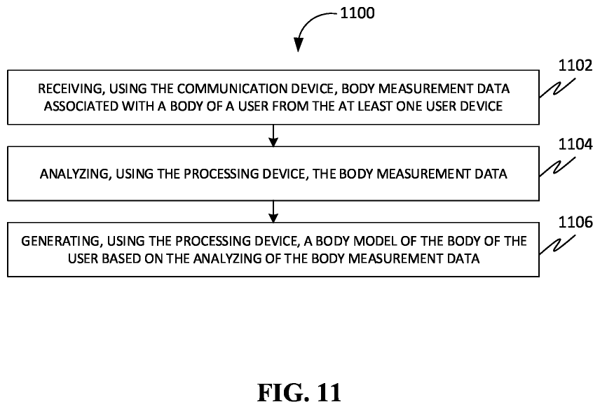

FIG. 11 is a flowchart of a method 1100 for generating a body model for facilitating the designing of the furniture, in accordance with some embodiments. Accordingly, at 1102, the method 1100 may include a step of receiving, using the communication device, body measurement data associated with a body of a user from the at least one user device. Further, the body measurement data may include at least one measurement of at least one of a shape, a size, and a weight of the body.

Further, at 1104, the method 1100 may include a step of analyzing, using the processing device, the body measurement data.

Further, at 1106, the method 1100 may include a step of generating, using the processing device, a body model of the body of the user based on the analyzing of the body measurement data. Further, the generating of the furnished room model may be based on the body model. Further, the body model may include a 2D body model, a 3D body model, etc.

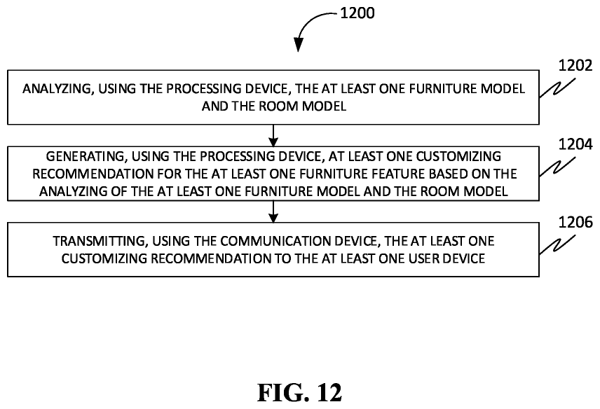

FIG. 12 is a flowchart of a method 1200 for generating at least one customizing recommendation for facilitating the designing of the furniture, in accordance with some embodiments. Accordingly, at 1202, the method 1200 may include a step of analyzing, using the processing device, the at least one furniture model and the room model.

Further, at 1204, the method 1200 may include a step of generating, using the processing device, at least one customizing recommendation for the at least one furniture feature based on the analyzing of the at least one furniture model and the room model.

Further, at 1206, the method 1200 may include a step of transmitting, using the communication device, the at least one customizing recommendation to the at least one user device. Further, the at least one furniture feature modification information corresponds to the at least one customizing recommendation.

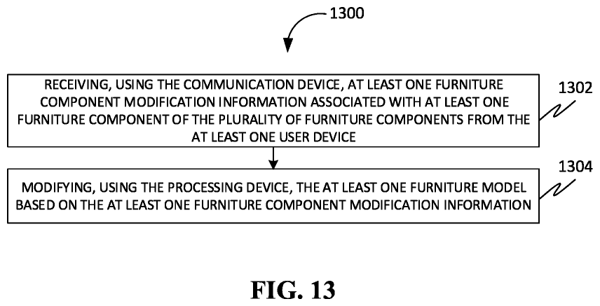

FIG. 13 is a flowchart of a method 1300 for generating at least one customizing recommendation for facilitating the designing of the furniture, in accordance with some embodiments. Accordingly, the at least one furniture may include a plurality of furniture components. Further, the plurality of furniture components may be customizable. Further, at 1302, the method 1300 may include a step of receiving, using the communication device, at least one furniture component modification information associated with at least one furniture component of the plurality of furniture components from the at least one user device.

Further, at 1304, the method 1300 may include a step of modifying, using the processing device, the at least one furniture model based on the at least one furniture component modification information. Further, the generating of the at least one modified furniture model may be based on the modifying of the at least one furniture model.

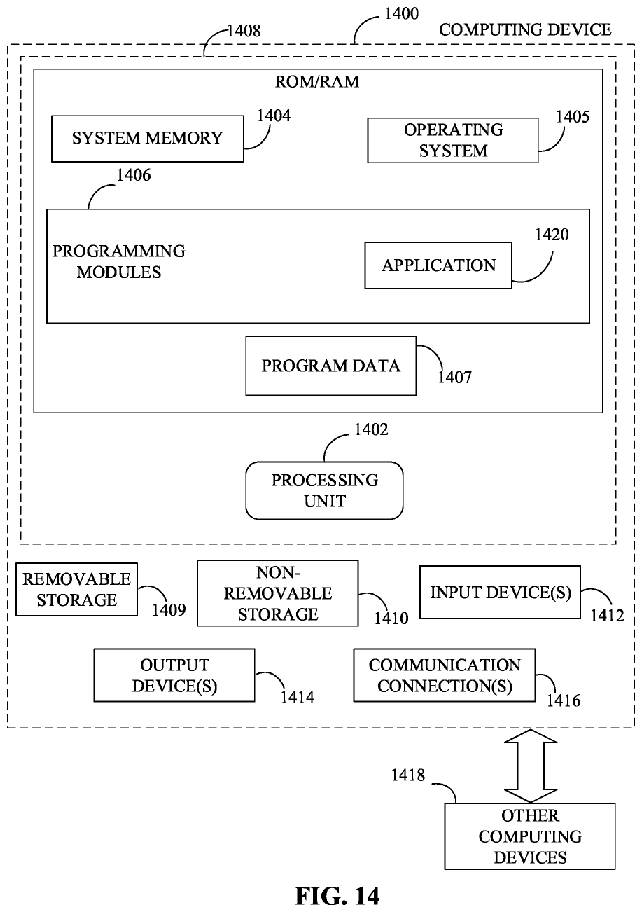

With reference to FIG. 14, a system consistent with an embodiment of the disclosure may include a computing device or cloud service, such as computing device 1400. In a basic configuration, computing device 1400 may include at least one processing unit 1402 and a system memory 1404. Depending on the configuration and type of computing device, system memory 1404 may comprise, but is not limited to, volatile (e.g. random-access memory (RAM)), non-volatile (e.g. read-only memory (ROM)), flash memory, or any combination. System memory 1404 may include operating system 1405, one or more programming modules 1406, and may include a program data 1407. Operating system 1405, for example, may be suitable for controlling computing device 1400's operation. In one embodiment, programming modules 1406 may include image-processing module, machine learning module. Furthermore, embodiments of the disclosure may be practiced in conjunction with a graphics library, other operating systems, or any other application program and is not limited to any particular application or system. This basic configuration is illustrated in FIG. 14 by those components within a dashed line 1408.

Computing device 1400 may have additional features or functionality. For example, computing device 1400 may also include additional data storage devices (removable and/or non-removable) such as, for example, magnetic disks, optical disks, or tape. Such additional storage is illustrated in FIG. 14 by a removable storage 1409 and a non-removable storage 1410. Computer storage media may include volatile and non-volatile, removable and non-removable media implemented in any method or technology for storage of information, such as computer-readable instructions, data structures, program modules, or other data. System memory 1404, removable storage 1409, and non-removable storage 1410 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 1400. Any such computer storage media may be part of device 1400. Computing device 1400 may also have input device(s) 1412 such as a keyboard, a mouse, a pen, a sound input device, a touch input device, a location sensor, a camera, a biometric sensor, etc. Output device(s) 1414 such as a display, speakers, a printer, etc. may also be included. The aforementioned devices are examples and others may be used.

Computing device 1400 may also contain a communication connection 1416 that may allow device 1400 to communicate with other computing devices 1418, such as over a network in a distributed computing environment, for example, an intranet or the Internet. Communication connection 1416 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

The term computer readable media as used herein may include both storage media and communication media.

As stated above, a number of program modules and data files may be stored in system memory 1404, including operating system 1405. While executing on processing unit 1402, programming modules 1406 (e.g., application 1420) may perform processes including, for example, one or more stages of methods, algorithms, systems, applications, servers, databases as described above. The aforementioned process is an example, and processing unit 1402 may perform other processes. Other programming modules that may be used in accordance with embodiments of the present disclosure may include machine learning applications. Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

Although the present disclosure has been explained in relation to its preferred embodiment, it is to be understood that many other possible modifications and variations can be made without departing from the spirit and scope of the disclosure.

What is claimed is:

1. A method for facilitating designing of furniture, the method comprising:
receiving, using a communication device, room information associated with a room from at least one user device;
analyzing, using a processing device, the room information;
generating, using the processing device, a room model of the room based on the analyzing of the room information;
retrieving, using a storage device, a plurality of furniture representations associated with a plurality of furniture, wherein the plurality of furniture is disposable in the room, wherein each furniture of the plurality of furniture is characterized by at least one furniture feature, wherein the at least one furniture feature is customizable;
transmitting, using the communication device, the plurality of furniture representations associated with the plurality of furniture to the at least one user device;
receiving, using the communication device, at least one furniture indication associated with at least one furniture of the plurality of furniture from the at least one user device;
retrieving, using the storage device, at least one furniture model of the at least one furniture based on the at least one furniture indication, wherein the at least one furniture model is characterized by at least one furniture model parameter corresponding to the at least one furniture feature;
generating, using the processing device, a furnished room model based on the at least one furniture model and the room model;
transmitting, using the communication device, the furnished room model to the at least one user device;
receiving, using the communication device, at least one furniture feature modification information associated with the at least one furniture feature of the at least one furniture from the at least one user device;
modifying, using the processing device, the at least one furniture model parameter of the at least one furniture model based on the at least one furniture feature modification information;
generating, using the processing device, at least one modified furniture model based on the modifying;
generating, using the processing device, a modified furnished room model based on the at least one modified furniture model and the room model; and
transmitting, using the communication device, the modified furnished room model to the at least one user device.

2. The method of claim 1 further comprising:
receiving, using the communication device, at least one sensor data from the at least one user device, wherein the at least one user device comprises at least one sensor, wherein the at least one sensor is configured for generating the at least one sensor data based on a location of a user;
analyzing, using the processing device, the at least one sensor data and the at least one modified furniture model;
generating, using the processing device, cost data associated with a cost of the at least one furniture based on the analyzing of the at least one sensor data and the at least one modified furniture model; and
transmitting, using the communication device, the cost data to the at least one user device.

3. The method of claim 1, wherein the room information comprises at least one room feature modification information, wherein the method further comprises:
transmitting, using the communication device, a primary room model of the room to the at least one user device, wherein the room is characterized by at least one room feature; and
modifying, using the processing device, at least one room model parameter of the primary room model corresponding to the at least one room feature based on the at least one room feature modification information, wherein the generating of the room model is based on the modifying of the at least one room model parameter.

4. The method of claim 1, wherein the at least one user device comprises at least one first sensor, wherein the at least one first sensor is configured for capturing at least one image of the room, wherein the room information comprises the at least one image of the room.

5. The method of claim 1, wherein the at least one furniture feature comprises at least one first furniture feature, wherein the at least one furniture model comprises at least one first furniture model parameter corresponding to the at least one first furniture feature, wherein the method further comprises:
analyzing, using the processing device, the room model and the at least one furniture model; and
modifying, using the processing device, the at least one first furniture model parameter of the at least one furniture model based on the analyzing of the room model and the at least one furniture model, wherein the generating of the at least one modified furniture model is further based on the modifying of the at least one first furniture model parameter.

6. The method of claim 1, wherein the at least one furniture feature comprises at least one second furniture feature, wherein the at least one furniture model comprises at least one second furniture model parameter corresponding to the at least one second furniture feature, wherein the method further comprises:
receiving, using the communication device, body measurement data associated with a body of a user from the at least one user device, wherein the body measurement data comprises at least one measurement of at least one of a shape, a size, and a weight of the body;
analyzing, using the processing device, the body measurement data and the at least one furniture model; and
modifying, using the processing device, the at least one second furniture model parameter of the at least one furniture model based on the analyzing of the body measurement data and the at least one furniture model, wherein the generating of the at least one modified furniture model is further based on the modifying of the at least one second furniture model parameter.

7. The method of claim 6, wherein the at least one user device comprises at least one measuring device, wherein the at least one measuring device is configured for measuring the at least one of the shape, the size, and the weight of the body, wherein the at least one measuring device is configured for generating the at least one measurement of the at least one of the shape, the size, and the weight of the body based on the measuring.

8. The method of claim 1 further comprising:
receiving, using the communication device, body measurement data associated with a body of a user from the at least one user device, wherein the body measurement data comprises at least one measurement of at least one of a shape, a size, and a weight of the body;
analyzing, using the processing device, the body measurement data; and
generating, using the processing device, a body model of the body of the user based on the analyzing of the body measurement data, wherein the generating of the furnished room model is further based on the body model.

9. The method of claim 1 further comprising:
analyzing, using the processing device, the at least one furniture model and the room model;
generating, using the processing device, at least one customizing recommendation for the at least one furniture feature based on the analyzing of the at least one furniture model and the room model; and
transmitting, using the communication device, the at least one customizing recommendation to the at least one user device, wherein the at least one furniture feature modification information corresponds to the at least one customizing recommendation.

10. The method of claim 1, wherein the at least one furniture comprises a plurality of furniture components, wherein the plurality of furniture components is customizable, wherein the method further comprising:
receiving, using the communication device, at least one furniture component modification information associated with at least one furniture component of the plurality of furniture components from the at least one user device; and
modifying, using the processing device, the at least one furniture model based on the at least one furniture component modification information, wherein the generating of the at least one modified furniture model is further based on the modifying of the at least one furniture model.

11. A system for facilitating designing of furniture, the system comprising:
a communication device configured for:
receiving room information associated with a room from at least one user device;
transmitting a plurality of furniture representations associated with a plurality of furniture to the at least one user device;
receiving at least one furniture indication associated with at least one furniture of the plurality of furniture from the at least one user device;
transmitting a furnished room model to the at least one user device;
receiving at least one furniture feature modification information associated with the at least one furniture feature of the at least one furniture from the at least one user device; and
transmitting a modified furnished room model to the at least one user device;
a processing device communicatively coupled with the communication device, wherein the processing device is configured for:
analyzing the room information;
generating a room model of the room based on the analyzing of the room information;
generating the furnished room model based on at least one furniture model and the room model;
modifying the at least one furniture model parameter of the at least one furniture model based on the at least one furniture feature modification information;
generating at least one modified furniture model based on the modifying; and
generating the modified furnished room model based on the at least one modified furniture model and the room model; and
a storage device communicatively coupled with the processing device, wherein the storage device is configured for:
retrieving the plurality of furniture representations associated with the plurality of furniture, wherein the plurality of furniture is disposable in the room, wherein each furniture of the plurality of furniture is characterized by at least one furniture feature, wherein the at least one furniture feature is customizable; and
retrieving the at least one furniture model of the at least one furniture based on the at least one furniture indication, wherein the at least one furniture model is characterized by at least one furniture model parameter corresponding to the at least one furniture feature.

12. The system of claim 11, wherein the communication device is further configured for:
receiving at least one sensor data from the at least one user device, wherein the at least one user device comprises at least one sensor, wherein the at least one sensor is configured for generating the at least one sensor data based on a location of a user; and
transmitting cost data to the at least one user device, wherein the processing device is further configured for:
analyzing the at least one sensor data and the at least one modified furniture model; and
generating the cost data associated with a cost of the at least one furniture based on the analyzing of the at least one sensor data and the at least one modified furniture model.

13. The system of claim 11, wherein the room information comprises at least one room feature modification information, wherein the communication device is further configured for transmitting a primary room model of the room to the at least one user device, wherein the room is characterized by at least one room feature, wherein the processing device is further configured for modifying at least one room model parameter of the primary room model corresponding to the at least one room feature based on the at least one room feature modification information, wherein the generating of the room model is based on the modifying of the at least one room model parameter.

14. The system of claim 11, wherein the at least one user device comprises at least one first sensor, wherein the at least one first sensor is configured for capturing at least one image of the room, wherein the room information comprises the at least one image of the room.

15. The system of claim 11, wherein the at least one furniture feature comprises at least one first furniture feature, wherein the at least one furniture model comprises at least one first furniture model parameter corresponding to the at least one first furniture feature, wherein the processing device is further configured for:
analyzing the room model and the at least one furniture model; and
modifying the at least one first furniture model parameter of the at least one furniture model based on the analyzing of the room model and the at least one furniture model, wherein the generating of the at least one modified furniture model is further based on the modifying of the at least one first furniture model parameter.

16. The system of claim 11, wherein the at least one furniture feature comprises at least one second furniture feature, wherein the at least one furniture model comprises at least one second furniture model parameter corresponding to the at least one second furniture feature, wherein the communication device is further configured for receiving body measurement data associated with a body of a user from the at least one user device, wherein the body measurement data comprises at least one measurement of at least one of a shape, a size, and a weight of the body, wherein the processing device is further configured for:
analyzing the body measurement data and the at least one furniture model; and
modifying the at least one second furniture model parameter of the at least one furniture model based on the analyzing of the body measurement data and the at least one furniture model, wherein the generating of the at least one modified furniture model is further based on the modifying of the at least one second furniture model parameter.

17. The system of claim 16, wherein the at least one user device comprises at least one measuring device, wherein the at least one measuring device is configured for measuring the at least one of the shape, the size, and the weight of the body, wherein the at least one measuring device is configured for generating the at least one measurement of the at least one of the shape, the size, and the weight of the body based on the measuring.

18. The system of claim 11, wherein the communication device is further configured for receiving body measurement data associated with a body of a user from the at least one user device, wherein the body measurement data comprises at least one measurement of at least one of a shape, a size, and a weight of the body, wherein the processing device is further configured for:
analyzing the body measurement data; and
generating a body model of the body of the user based on the analyzing of the body measurement data, wherein the generating of the furnished room model is further based on the body model.

19. The system of claim 11, wherein the processing device is further configured for:
analyzing the at least one furniture model and the room model; and
generating at least one customizing recommendation for the at least one furniture feature based on the analyzing of the at least one furniture model and the room model, wherein the communication device is further configured for transmitting the at least one customizing recommendation to the at least one user device, wherein the at least one furniture feature modification information corresponds to the at least one customizing recommendation.

20. The system of claim 11, wherein the at least one furniture comprises a plurality of furniture components, wherein the plurality of furniture components is customizable, wherein the communication device is further configured for receiving at least one furniture component modification information associated with at least one furniture component of the plurality of furniture components from the at least one user device, wherein the processing device is further configured for modifying the at least one furniture model based on the at least one furniture component modification information, wherein the generating of the at least one modified furniture model is further based on the modifying of the at least one furniture model.
